(19) United States
(12) Patent Application Publication
(10) Pub. No.: US 2009/0061960 A1
(43) Pub. Date: Mar. 5, 2009

(54) ELECTRONIC DEVICE WITH A PANEL CAPABLE OF BEING HIDDEN SELECTIVELY

(76) Inventors: Kai-Jung Chang, Taoyuan County (TW); Yi-Yen Lin, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/192,134

(22) Filed: Aug. 15, 2008

(30) Foreign Application Priority Data
Aug. 30, 2007 (TW) 096132320

(51) Int. Cl. H04M 1/00

(52) U.S. Cl. 455/575.3

(57) ABSTRACT

A folding mobile phone includes a main body including a first housing, and a processing unit installed inside the first housing for controlling operation of the folding mobile phone. The folding mobile phone further includes a display module pivoted to the main body in a foldable manner. The display module includes a second housing. The folding mobile phone further includes a panel connected to a first side of the first housing and a first side of the second housing in a rotatable manner. When the display module rotates to a first position relative to the main body, the first housing and the second housing shield the panel together, and when the display module rotates to a second position relative to the main body, at least part of the panel exposes out of the first housing and the second housing.

### BACKGROUND OF THE INVENTION

1. Field of the Invention

The present invention relates to a folding mobile phone, and more particularly, to a folding mobile phone capable of hiding a key selectively.

2. Description of the Prior Art

In general, MP3 playing keys and numerical keys of a bar-type mobile phone with a MP3 playing function are disposed together, and even there is no independent MP3 playing key. Therefore when a user uses the MP3 playing function of the mobile phone as a MP3 player, the numerical keys for dialing still show up and occupy space.

### SUMMARY OF THE INVENTION

It is therefore a primary objective of the claimed invention to provide a folding mobile phone capable of hiding a key selectively for solving the above-mentioned problem.

According to the claimed invention, a folding mobile phone includes a main body including a first housing, and a processing unit installed inside the first housing for controlling operation of the folding mobile phone. The folding mobile phone further includes a display module pivoted to the main body in a foldable manner. The display module includes a second housing. The folding mobile phone further includes a panel connected to a first side of the first housing and a first side of the second housing in a rotatable manner. When the display module rotates to a first position relative to the main body, the first housing and the second housing shield the panel together, and when the display module rotates to a second position relative to the main body, at least part of the panel exposes out of the first housing and the second housing.

According to the claimed invention, an electronic device includes a main body including a first housing, and a processing unit installed inside the first housing for controlling operation of the electronic device. The electronic device further includes a rotary module pivoted to the main body in a foldable manner, which includes a second housing, and a panel connected to a first side of the first housing and a first side of the second housing in a rotatable manner. When the rotary module rotates to a first position relative to the main body, the first housing and the second housing shield the panel together, and when the display module rotates to a second position relative to the main body, at least part of the panel exposes out of the first housing and the second housing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a folding mobile phone according to an embodiment of the present invention.

FIG. 2 is an exploded drawing of the folding mobile phone according to the embodiment of the present invention.

FIG. 3 is an exploded drawing of the folding mobile phone in an unfolded situation according to the embodiment of the present invention.

FIG. 4 is a drawing of the folding mobile phone in a half unfolded situation according to the embodiment of the present invention.

FIG. 5 is a drawing of the folding mobile phone in a folded situation according to the embodiment of the present invention.

### DETAILED DESCRIPTION

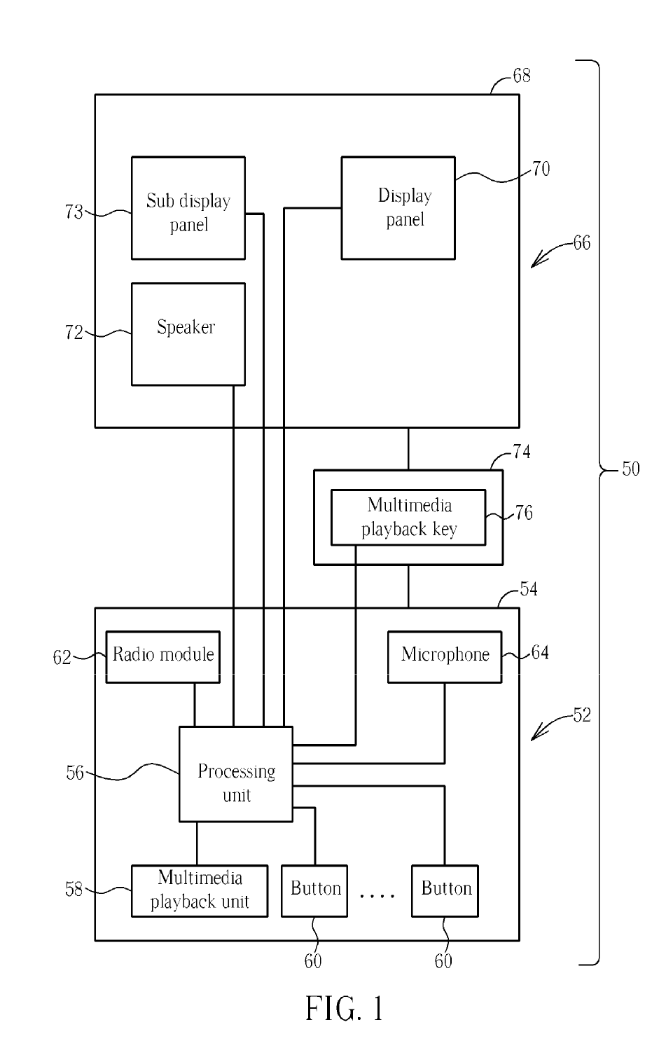

Please refer to FIG. 1. FIG. 1 is a functional block diagram of a folding mobile phone 50 according to an embodiment of the present invention. The folding mobile phone 50 includes a main body 52 including a first housing 54, a processing unit 56 installed inside the first housing 54 for controlling operation of the folding mobile phone 50, a multimedia playback unit 58 installed inside the first housing 54 and coupled to the processing unit 56 for playing multimedia data, a plurality of buttons 60 installed on the first housing and coupled to the processing unit 56 for inputting control signals to the processing unit 56 which a user can dial with buttons 60, a radio module 62 installed in the first housing 54 and coupled to the processing module 56 for receiving radio signals to generate corresponding communication signals and sending them to the processing module 56 as well as outputting data from the processing module 56 wirelessly, and a microphone 64 coupled to the processing module 56 for converting real sound into audio signals and sending them to the processing module 56. The folding mobile phone 50 further includes a display module 66 pivoted to the main body 52 in a foldable manner. The display module 66 includes a second housing 68, a display panel 70 installed inside the second housing 68 and coupled to the processing unit 56 for converting data transmitted from the processing unit 56 into images, a speaker 72 installed inside the second housing 68 and coupled to the processing unit 56 for converting data transmitted from the processing unit 56 into acoustic waves, and a sub display module 73 installed on the second housing 68 and coupled to the processing unit 56 for converting data transmitted from the processing unit 56 into images, such as displaying images of time or information of using the multimedia playback unit 58, like an image for showing a playing song. The folding mobile phone 50 further includes a keypad housing 74 connected to the first housing 54 and the second housing 68 in a rotatable manner. A multimedia playback key 76 is disposed on the keypad housing 74 and coupled to the processing unit 56 for inputting a control signal to the processing unit 56 so as to control operation of the multimedia playback unit 58. The multimedia playback unit 58 can be a MP3 playback unit, and the multimedia playback key 76 can be a MP3 playback key accordingly. The keypad housing 74 can be substituted for other panels, such as a touch panel or a screen.

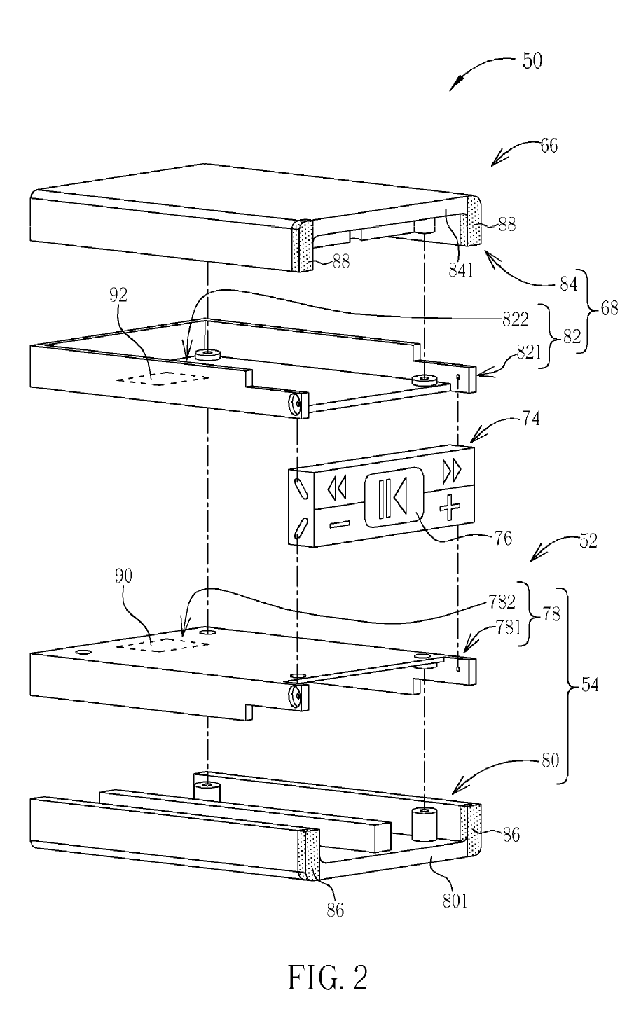

Please refer to FIG. 2. FIG. 2 is an exploded drawing of the folding mobile phone 50 according to the embodiment of the present invention. The first housing 54 of the main body 52 includes a first covering 78, and a second covering 80 connected to the first covering 78 for covering the processing unit 56, the radio module 62, and the microphone 64 shown in FIG. 1 with the first covering 78 together. The second housing 68 of the display module 66 includes a third covering 82, and a fourth covering 84 connected to the third covering 82 for covering the display panel 70, and the speaker 72 shown in FIG. 1 together. The keypad housing 74 can be laterally screwed to or riveted to a first side 781 of the first housing 78 and a first side 821 of the second housing 82 so that the keypad housing 74 is connected to the first housing 54 and the second housing 68 in a rotatable manner. The keypad housing 74 can be laterally screwed to or riveted to the first side 781 of the first housing 78 and the first side 821 of the second housing 82 on one side or on both sides. The main body 52 further includes two first magnetic components 86 installed on a first side 801 of the second covering 80 respectively, and the display module 66 further includes two second magnetic components 88 installed on a first side 841 of the fourth covering 84 respectively. The first magnetic components 86 and the second magnetic components 88 are disposed with opposite poles. That is, a side of the first magnetic components 86 nearby the keypad housing 74 can be in N-pole, and a side of the second magnetic components 88 nearby the keypad housing 74 can be in S-pole. Or a side of the first magnetic components 86 nearby the keypad housing 74 can be in S-pole, and a side of the second magnetic components 88 nearby the keypad housing 74 can be in N-pole. The main body 58 further includes a third magnetic component 90 installed on a second side 782 of the first covering 78, and the display module 66 further includes a fourth magnetic component 92 installed on a second side 822 of the third covering 82. The third magnetic component 90 and the fourth magnetic component 88 are disposed with opposite poles. The first magnetic component 86, the second magnetic component 88, the third magnetic component 90, and the fourth magnetic component 92 can be magnets.

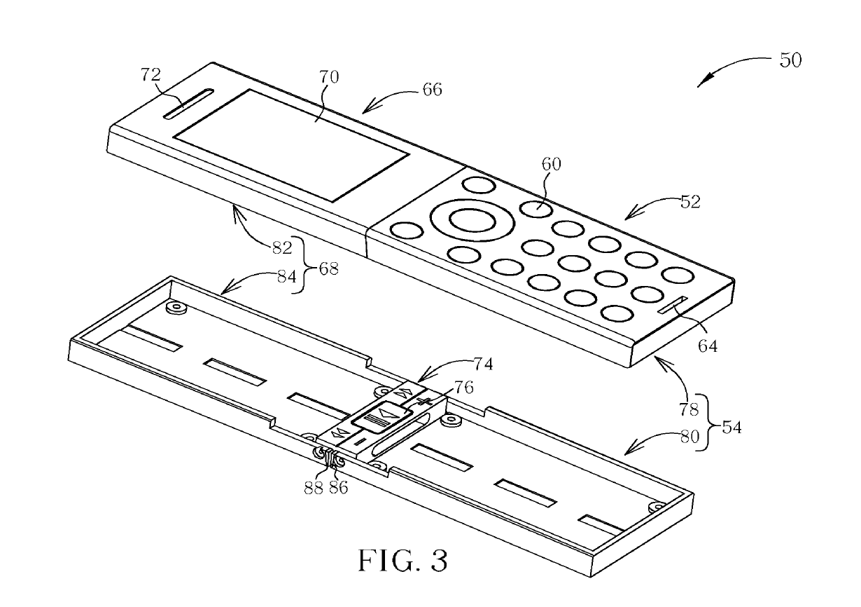

Please refer to FIG. 3. FIG. 3 is an exploded drawing of the folding mobile phone 50 in an unfolded situation according to the embodiment of the present invention. When the user rotates the display module 66 to a first position relative to the main body 52, that is the angle between the display module 66 and the main body 52 is 180 degrees substantially, the first magnetic component 86 and the second magnetic component 88 attract each other so that the folding mobile phone 50 can be fixed in the unfolded situation. At this time, the keypad housing 74 rotates to a position where the first housing 54 and the second housing 68 are capable of shielding the keypad housing 74 together. The buttons 60 on the first housing 54 are exposed, and the user can dial with the buttons 60. At this time, the folding mobile phone 50 corresponds to a use mode of a bar-type mobile phone.

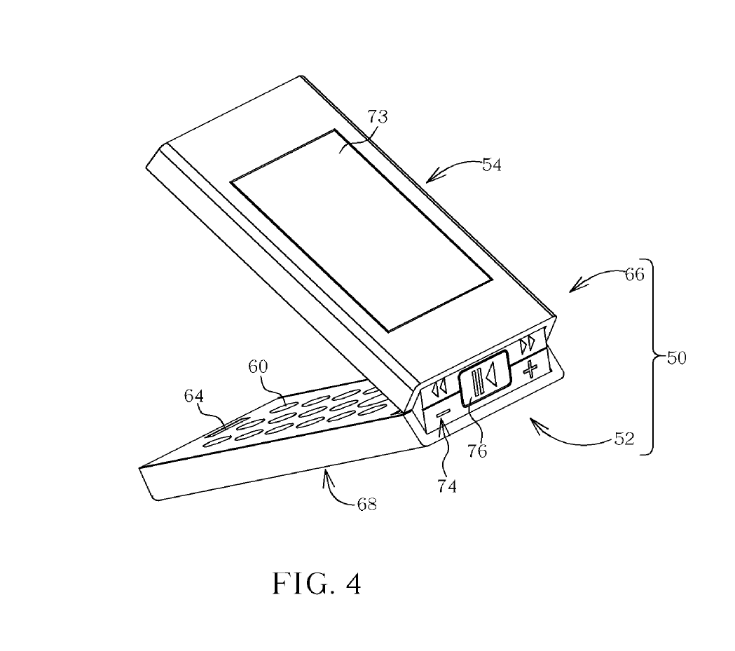

Please refer to FIG. 4. FIG. 4 is a drawing of the folding mobile phone 50 in a half unfolded situation according to the embodiment of the present invention. When the user rotates the display module 66 from the first position relative to the main body 52 so as to reduce the angle between the display module 66 and the main body 52, the user has to overcome attractive force of the first magnetic component 86 and the second magnetic component 88. At this time, at least part of the keypad housing 74 exposes out of the first housing 54 and the second housing 58 increasingly.

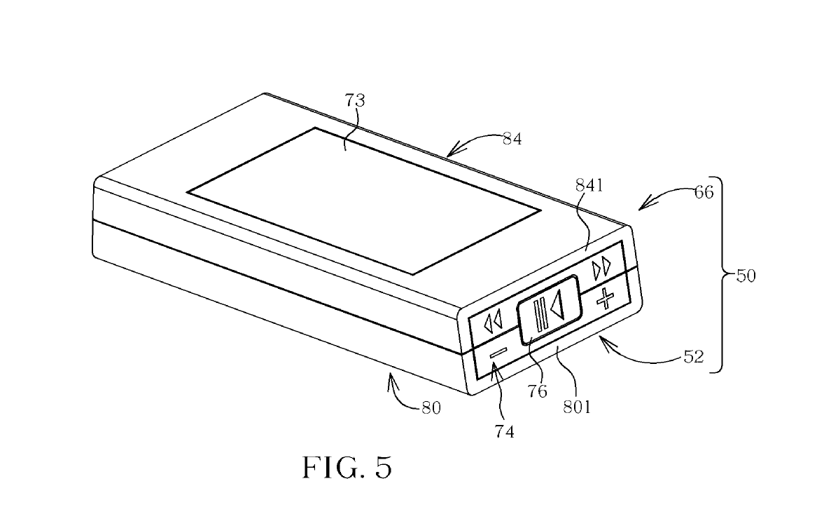

Please refer to FIG. 5. FIG. 5 is a drawing of the folding mobile phone 50 in a folded situation according to the embodiment of the present invention. When the user rotates the display module 66 from the first position to a second position relative to the main body 52, that is the angle between the display module 66 and the main body 52 is zero degree substantially, the keypad housing 74 rotates at 90 degrees substantially. At this time, the keypad housing 74, the multimedia playback key 76, the first side 801 of the second covering 80, and the first side 841 of the fourth covering 84 are substantially on a same plane. When the display module 66 rotates to the second position relative to the main body 52, the third magnetic component 90 and the fourth magnetic component 92 attract each other so that the folding mobile phone 50 can be fixed in the folded situation. At this time, the keypad housing 74 rotates to a position where the keypad housing 74 exposes out of the first housing 54 and the second housing 68 completely and the buttons 60 on the first housing 54 are shielded completely. The user can operate the multimedia playback unit 58 with the multimedia playback key 76 on the keypad housing 74, such as playing MP3 files. The sub display panel 73 on the second housing 68 can display information of using the multimedia playback unit 58, like an image of the playing song. At this time, the buttons 60, such as numerical buttons or dialing buttons, not utilized when operating multimedia playback function cab be hidden, and the multimedia playback key 76 and the sub display panel 73 can expose so that the folding mobile phone 50 corresponds to a use mode of a MP3 player.

In conclusion, the mechanism of the folding mobile phone 50 makes the folding mobile phone 50 a MP3 player in the folded situation that numerical buttons can be hidden and the MP3 playback key and the sub display panel can be exposed, and makes the folding mobile phone 50 a bar-type mobile phone in the unfolded situation that the MP3 playback key can be hidden and numerical buttons can be exposed. The attractive force of the magnetic components can fix the folding mobile phone in the folded situation or in the unfolded situation.

Besides, the folding mobile phone 50 of the present invention can be substituted by other portable electronic devices, such as a personal digital assistant (PDA). The present invention provides a mechanism for hiding the key selectively, so the multimedia playback unit 58 and the multimedia playback key 76 can be substituted by other output modules and corresponding keys.

In contrast to the conventional mobile phone, the folding mobile phone of the present invention can correspond to a MP3 player in the folded situation when hiding numerical buttons of the folding mobile phone and exposing the MP3 playback key and the sub display panel and correspond to a bar-type mobile phone in the unfolded situation when hiding the MP3 playback key and exposing numerical buttons of the folding mobile phone. The folding mobile phone of the present invention has characteristics of a normal mobile phone and a MP3 player. The folding mechanism of the present invention brings the mobile phone in a small size for convenient carry.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A folding mobile phone comprising:
a main body comprising:
a first housing; and
a processing unit installed inside the first housing for controlling operation of the folding mobile phone; and
a display module pivoted to the main body in a foldable manner, the display module comprising a second housing; and
a panel connected to a first side of the first housing and a first side of the second housing in a rotatable manner;
wherein when the display module rotates to a first position relative to the main body, the first housing and the second housing shield the panel together, and when the display module rotates to a second position relative to the main body, at least part of the panel exposes out of the first housing and the second housing.

2. The folding mobile phone of claim 1 wherein the panel is a keypad housing comprising a key coupled to the processing unit for inputting a control signal to the processing unit.

3. The folding mobile phone of claim 2 wherein the main body further comprises a multimedia playback unit installed inside the first housing and coupled to the processing unit for playing multimedia data, and the key is a multimedia playback key.

4. The folding mobile phone of claim 1 wherein the panel is a touch panel coupled to the processing unit for inputting a control signal to the processing unit.

5. The folding mobile phone of claim 1 wherein the panel is laterally screwed to the first side of the first housing and the first side of the second housing.

6. The folding mobile phone of claim 1 wherein the panel is laterally riveted to the first side of the first housing and the first side of the second housing.

7. The folding mobile phone of claim 1 wherein the first housing comprises a first covering and a second covering connected to the first covering for covering the processing unit with the first covering together, the second housing comprises a display panel, a third covering and a fourth covering connected to the third covering for covering the display panel together, the panel is connected to a first side of the first covering and a first side of the third covering in a rotatable manner, the first side of the first covering is the first side of the first housing, and the first side of the third covering is the first side of the second housing.

8. The folding mobile phone of claim 7 wherein the main body further comprises a first magnetic component installed on a first side of the second covering, and the display module further comprises a second magnetic component installed on a first side of the fourth covering for attracting the first magnetic component when the display module rotates to the first position relative to the main body.

9. The folding mobile phone of claim 7 wherein the main body further comprises a third magnetic component installed on a second side of the first covering, and the display module further comprises a fourth magnetic component installed on a second side of the third covering for attracting the third magnetic component when the display module rotates to the second position relative to the main body.

10. The folding mobile phone of claim 1 wherein when the display module rotates to the second position relative to the main body, the panel, the first side of the first housing, and the first side of the second housing are substantially on a same plane.

11. The folding mobile phone of claim 8 wherein when the display module rotates to the second position from the first position relative to the main body, the panel rotates at 90 degrees substantially.

12. An electronic device comprising:
a main body comprising:
a first housing; and
a processing unit installed inside the first housing for controlling operation of the electronic device;
a rotary module pivoted to the main body in a foldable manner, the rotary module comprising a second housing; and
a panel connected to a first side of the first housing and a first side of the second housing in a rotatable manner;
wherein when the rotary module rotates to a first position relative to the main body, the first housing and the second housing shield the panel together, and when the display module rotates to a second position relative to the main body, at least part of the panel exposes out of the first housing and the second housing.

13. The electronic device of claim 12 wherein the panel is a keypad housing comprising a key coupled to the processing unit for inputting a control signal to the processing unit.

14. The electronic device of claim 12 wherein the panel is laterally screwed to the first side of the first housing and the first side of the second housing.

15. The electronic device of claim 12 wherein the panel is laterally riveted to the first side of the first housing and the first side of the second housing.

16. The electronic device of claim 12 wherein the first housing comprises a first covering and a second covering connected to the first covering for covering the processing unit with the first covering together, the second housing comprises a third covering and a fourth covering connected to the third covering, the panel is connected to a first side of the first covering and a first side of the third covering in a rotatable manner, the first side of the first covering is the first side of the first housing, and the first side of the third covering is the first side of the second housing.

17. The electronic device of claim 16 wherein the main body further comprises a first magnetic component installed on a first side of the second covering, and the rotary module further comprises a second magnetic component installed on a first side of the fourth covering for attracting the first magnetic component when the rotary module rotates to the first position relative to the main body.

18. The electronic device of claim 16 wherein the main body further comprises a third magnetic component installed on a second side of the first covering, and the rotary module further comprises a fourth magnetic component installed on a second side of the third covering for attracting the third magnetic component when the rotary module rotates to the second position relative to the main body.

19. The electronic device of claim 12 wherein when the rotary module rotates to the second position relative to the main body, the panel, the first side of the first housing, and the first side of the second housing are substantially on a same plane.

20. The electronic device of claim 12 wherein when the display module rotates to the second position from the first position relative to the main body, the panel rotates at 90 degrees substantially.
